(19) United States
(12) Patent Application Publication
(10) Pub. No.: US 2016/0268619 A1
(43) Pub. Date: Sep. 15, 2016

(54) FUEL CELL

(71) Applicants: Nippon Kodoshi Corporation, Haruno-cho (JP); Toyota Jidosha Kabushiki Kaisha, Aichi-ken (JP)

(72) Inventors: Haruo SAWA, Kochi-shi (JP); Haruyuki Nakanishi, Nogoya-shi (JP)

(73) Assignees: Nippon Kodoshi Corporation, Haruno-cho (JP); Toyota Jidosha Kabushiki Kaisha, Aichi-ken (JP)

(21) Appl. No.: 15/065,034

(22) Filed: Mar. 9, 2016

(30) Foreign Application Priority Data
Mar. 13, 2015 (JP) 2015-051218

(51) Int. Cl. H01M 8/1009; H01M 8/1025

(52) U.S. Cl. CPC H01M 8/1009; H01M 8/1025; H01M 2008/1095

(57) ABSTRACT

A fuel cell includes an anode that is supplied with a gas containing an anode active material for being oxidized, a cathode that is supplied with a liquid containing a nonvolatile cathode active material for being reduced, and an electrolyte membrane that separates the anode and the cathode, and the electrolyte membrane comprises an inorganic/organic hybrid compound that is formed by chemical bonding of polyvinyl alcohol with an inorganic compound including at least one compound selected from the group consisting of silicic acid compounds, a tungstic acid compounds, and zirconic acid compounds.

### CROSS-REFERENCE TO RELATED APPLICATIONS

This application claims priority to Japanese Patent Application No. 2015-051218, filed on Mar. 13, 2015, which is hereby incorporated by reference.

### FIELD OF THE INVENTION

The present invention relates to fuel cells wherein a liquid containing active material is supplied to a cathode.

### BACKGROUND OF THE INVENTION

Fuel cells have gathered attention recently as a new power source. As a typical example, a hydrogen-oxygen fuel cell provides electricity directly through an electrochemical reaction of hydrogen and oxygen (air) with only water being discharged from the cell itself, so is clean and excellent in quietness. Hydrogen can be produced through electrolysis of water by using natural energy such as wind power and sunlight, bringing about a lot of benefits in term of CO₂ reduction and abandonment of nuclear power and petroleum energy. That is why the fuel cell is applied to vehicles, and such fuel cell vehicles are already commercially available. Further, the fuel cell has become popular as household cogeneration units owing to high energy efficiency by using with exhaust heat, and as backup power systems owing to continuous power supply for long periods without requiring periodic replacement. The fuel cell is also noted as power source for working vehicles in terms of operational efficiency since it does not require long charging time unlike a secondary battery. In this way, the fuel cell is expected to prevail at an accelerating pace as an electrochemical system indispensable for life and society.

The fuel cell is constituted by being separated into two sides with an electrolyte membrane, one is for supplying fuel such as hydrogen, the other is for supplying oxygen (air). The fuel as an anode active material has a property of donating electrons to oxygen as a cathode active material. When the anode and the cathode are connected with an external circuit, electrons travel from the anode active material to the cathode active material through it and an electric current flows. If both active materials directly come in contact with each other, electrons are directly donated and accepted, causing so called a short circuit and preventing taking electricity out. That is why both electrodes are separated by the electrolyte membrane. Nonetheless, the electric current does not continue to flow only with electrons traveling through the external circuit between both electrodes, because charge with the same polarity accumulates on the respective electrodes. Hence the electrolyte membrane allows ions to conduct between the both electrodes so as to discharge the accumulation of the charge and to obtain a constant electric current. The reaction of the most typical hydrogen-oxygen fuel cell is:

H₂→2H⁺+2e⁻ (1)

1/2O₂+2H⁺+2e⁻→H₂O (2)

The fuel is not limited to a gas, but a liquid having a property of donating electrons to oxygen may be used as an active material. As an example, a direct methanol fuel cell (DMFC) in which a methanol aqueous solution is supplied to the anode has been conventionally provided. In a case of DMFC, it is methanol that donates electrons to oxygen on the cathode, thereafter it converts into water, carbon dioxide and hydrogen ions. As an electrolyte membrane in this case, for example, perfluorosulfonic acid-based electrolyte membrane having proton conductivity, which is sold under the trade name Nafion® (DuPont), is generally used. In conventional electrolyte membranes, protons move with assistance of water molecules in the membrane and thus a large amount of water is required to be absorbed. For this reason, methanol in the anode side crosses over to the cathode side as well as water in the methanol aqueous solution in a DMFC. Particularly in Nafion®, hydrophilic side chains aggregate each other forming a very large space in the molecular secondary structure, and water and methanol easily cross over through it.

Meanwhile, there is an electrolyte membrane allowing less crossover of methanol to a cathode than a Nafion® membrane, for example, an electrolyte membrane based on hydrocarbon engineering plastic such as polyetheretherketone (PEEK) is provided. As to the other electrolyte membrane that is less expensive but has excellent chemical stability in addition to allowing less crossover of methanol, a membrane made of not a pure organic polymer but an inorganic/organic hybrid compound is suggested, wherein the hybrid compound is composed of mainly a silicic acid compound, a tungstic acid compound, or a zirconic acid compound is chemically bonded with polyvinyl alcohol. (Japanese Patents No. 4832670, No. 3889605, No. 4081343, No. 4041422, No. 4516284, No. 4516285, No. 4744121, No. 4871225, Japanese Unexamined Patent Application Publication No. 2010-238525)

When the fuel cell is more broadly defined as a cell using a fluid, such as a gas and a liquid, as an active material, a system contrary to the case of DMFC is conceivable, wherein the anode is a gas electrode, for example a hydrogen electrode, and the cathode is a liquid electrode. One example of that is the system wherein an active material, in which ions or compounds having a tendency to accept electrons from hydrogen are solved or dispersed in a liquid such as water, is supplied to the cathode. Some type of vanadic acid ion or manganic acid ion has this property and the aqueous solution or the dispersion liquid thereof is used to constitute the cell.

The abovementioned cell can be constituted by supplying a solution containing molybdovanadophosphoric acid as a vanadium ion compound. In this case, the molybdovanadophosphoric acid becomes a reduced form by receiving electrons after generating electricity, in turn, it reconverts into the oxidized form through oxidation when it is contacted with oxygen. This means that the molybdovanadophosphoric acid may be used as a mediator, it allows the cathode to operate indirectly to oxygen via the mediator without contacting with it directly. In this case, although molybdovanadophosphoric acid as a mediator is oxidized and reduced repeatedly, its total quantity is kept constant. One of the advantages of applying this system is to allow the electrode and oxygen (air) to place apart from each other owing to intermediation with the liquid containing mediator that reacts directly at the cathode. Further, in the case that oxygen reacts directly at the cathode, as is often the case with electrodes of fuel cells, supplied oxygen, which is gas, is blocked by the generated water; however, in the system using mediator, no elaborate control of gas-liquid phases is needed at all since it is not gas but liquid that reacts at the electrode.

A platinum catalyst, which is expensive and rare resource, is generally used when oxygen is directly reacted at the electrode in fuel cells. If an oxidized form of the mediator is able to be easily reduced on the cathode, the following advantages are brought in: the quantity of expensive platinum catalyst can be reduced; platinum catalyst can be substituted with other inexpensive one; no catalyst is required. As the larger quantity of platinum is used at the cathode in the conventional fuel cells, such reduction in the quantity of platinum used at the cathode has a profound effect in particular. If a large amount of oxygen dissolves in a liquid, the reaction of the oxygen and the mediator proceeds in a very large three-dimensional region, so it proceeds rapidly. In other words, the mediator itself does not change substantially but does assist the electrode reaction with oxygen, which is regarded as a catalyst. That is, the liquid containing the mediator can be regarded as the liquid containing the catalyst, so the quantity of platinum, the conventional catalyst, can be reduced by replacing it with the liquid catalyst. In this way, the use of liquid catalyst may produce more effects than a solid electrode catalyst as long as being separated with an adequate electrolyte membrane.

### SUMMARY OF THE INVENTION

### Problems to be Solved by the Invention

As described above, the fuel cell in which a liquid containing active materials are supplied to the cathode has significant advantages. For example, it does not need elaborate control of gas-liquid phases and allows a large reduction in the quantity of platinum used at the reacting electrode. However, there are some serious problems to be solved for practical use. If a Nafion® electrolyte membrane, which has been conventionally used, is employed in the fuel cell in which the liquid containing active material supplied to the cathode, crossover of the liquid to the anode, the gas side, occurs.

The crossover as described above is not so serious problem in a case of DMFC. In this case, although the water crossed over to the cathode makes the electrode wet and blocks the contact with oxygen inhibiting the reaction, water is volatile and evaporates constantly from the electrode without keeping to accumulate on the electrode. It is also possible to remove water to some extent by providing the electrode with hydrophobicity. In addition, since oxygen has high solubility in water, oxygen dissolved in water reacts even if the electrode is wet on some level and does not become a major factor of reaction inhibition

The methanol crossed over to the cathode is also volatile so does not keep to accumulate on the electrode. Furthermore, since methanol is oxidized when it reached on the cathode and converts into water and carbon dioxide, it does not keep accumulating on the electrode. For this reason, although crossover of methanol aqueous solution is not favorable in terms of the cell performance, it does not cause a serious problem making the cell impossible to operate in the case of the DMFC wherein the solution is supplied to the anode. That is, the serious cross-over problem can be avoided by the following conditions: 1) the substance crossing over is volatile and does not keep to accumulate on the electrode; 2) the substance generated through oxidation-reduction reaction is volatile and does not keep to accumulate on the electrode; and 3) the cathode active material is oxygen having high solubility in water.

In contrast to the DMFC case, if the active material crossed over is solid or nonvolatile, it keeps accumulating on the electrode and inhibits an electrode reaction. Accordingly, in the fuel cell as described above in which the liquid containing an active material is supplied to the cathode, if the aqueous solution of a substance which is originally solid, for example metal ion, is supplied to the cathode, it crosses over to the anode and accumulates on the electrode, inhibiting the electrode reaction. In principle, the cathode active material crossed over to the anode is instantly reduced and converted into a reduced form. Nonetheless, also the reduced form is solid and nonvolatile, so keeps to accumulate on the electrode.

If the liquid containing an active material is water, the water crossed over to the anode side covers the electrode, resulting in inhibition of hydrogen reaction. In the case of the abovementioned DMFC case, water covering the electrode surface does not necessarily lead to a significant inhibition, since oxygen, an active material of the oxygen electrode, has high solubility in water. However, for the anode, water covering the electrode becomes a big reason for a reaction inhibition since hydrogen has very low solubility in water. It is ideal for these fuel cells to operate at higher temperature to enhance power output; however, it is difficult for Nafion® to operate at high temperature since Nafion® whose glass transition point (softening point) is at around 100° C. allows the liquid contacting the cathode to cross over more easily at that temperature. Other than Nafion®, there are electrolyte membranes based on hydrocarbon engineering plastics such as PEEK. However, they have less chemical stability such as resistance to oxidation and radical attacks than fluorine polymer based electrolytes including Nafion® and, in particular, are likely to cause a problem of durability when used at high temperatures.

In view of the above problems, the object of the present invention is to solve the problem of crossover of liquid which is essential to remarkably improve applicability to practical use of the fuel cell wherein a liquid containing an active material is supplied to a cathode and providing advantageous effects such as reducing the quantity of platinum catalyst to be used.

### Means of Solving the Problems

According to one aspect of the present invention, a fuel cell includes an anode that is supplied with a gas containing an anode active material for being oxidized, a cathode that is supplied with a liquid containing a nonvolatile cathode active material for being reduced, and an electrolyte membrane that separates the anode and the cathode. The electrolyte membrane includes an inorganic/organic hybrid compound that is formed by chemical bonding of polyvinyl alcohol and an inorganic compound includes at least one compound selected from the group consisting of silicic acid compounds, tungstic acid compounds, and zirconic acid compounds.

According to another aspect of the present invention; the anode active material contained in the gas supplied to the anode is hydrogen; the nonvolatile cathode active material contained in the liquid supplied to the cathode is selected from the group consisting of vanadic acid ions, manganic acid ions, and compounds thereof; the nonvolatile cathode active material contained in the liquid supplied to the cathode is molybdovanadophosphoric acid; the liquid supplied to the cathode contacts with oxygen as well as the cathode, by which the reduced form of the nonvolatile cathode active material in the liquid, formed by being reduced on the cathode, is reconverted into an oxidized form by being contacted and oxidized with oxygen.

### Effects of the Invention

According to the present invention, the inorganic/organic hybrid compound, not a pure organic polymer, is used for the electrolyte membrane. Due to that, performance of separation of the membrane is enhanced, the liquid containing the cathode active material supplied to the cathode is prevented from crossing over to the anode, and it solves the problem that accumulation of a nonvolatile cathode active material on the anode inhibits the electrode reaction. This solves the problem in the fuel cell in which the gas containing the anode active material for being oxidized is supplied to the anode and the liquid containing the nonvolatile cathode active material for being reduced is supplied to the cathode. That leads to a large reduction in the quantity of platinum catalyst to be used in the reacting electrode, and make it possible to establish the fuel cell without requiring an elaborate control of gas-liquid phases.

### BRIEF DESCRIPTION OF THE DRAWING

FIG. 1 is a schematic view showing one example of a main part of a fuel cell in accordance with an embodiment of the present invention.

FIG. 2 is a schematic view showing another example of the main part of the fuel cell in accordance with an embodiment of the present invention.

FIG. 3 is a flowchart schematically showing one example of producing an electrolyte membrane.

FIG. 4 is a flowchart schematically showing another example of producing the electrolyte membrane.

FIG. 5 is a current-voltage curve of the fuel cell in accordance with an embodiment of the present invention.

FIG. 6 is a power output curve of the fuel cell in accordance with an embodiment of the present invention.

### DESCRIPTION OF THE EMBODIMENTS

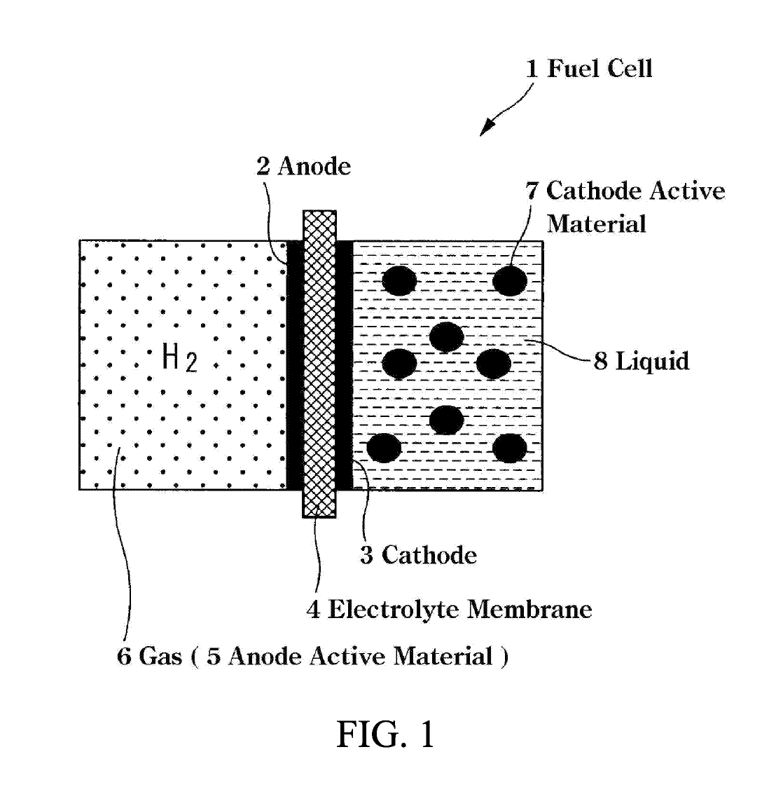

A preferred embodiment of the present invention will be described with reference to the accompanying drawings. FIG. 1 is a schematic view showing one example of a main part of a fuel cell in accordance with an embodiment of the present invention. A fuel cell 1 in which an anode 2 and a cathode 3 are separated from each other by an electrolyte membrane 4 is constituted in such a way that a gas 6 containing an anode active material 5 for being oxidized is supplied to the anode 2, whereas a liquid 8 containing a nonvolatile cathode active material 7 for being reduced is supplied to the cathode 3. That is, in contrast to a case of DMFC, the anode 2 is supplied with the gas 6 and the cathode 3 is supplied with the liquid 8 in the fuel cell 1. As for the anode active material 5, hydrogen is mainly used. As for the cathode active material 7 in the role of nonvolatile active material for being reduced, metal ions or compounds thereof having a property of receiving electrons from hydrogen, for example, vanadic acid ions, manganic acid ions, or compounds thereof are used. The active material 7 is used in the form of an aqueous solution by dissolving in water, the liquid 8, or of a dispersion liquid by dispersing in water.

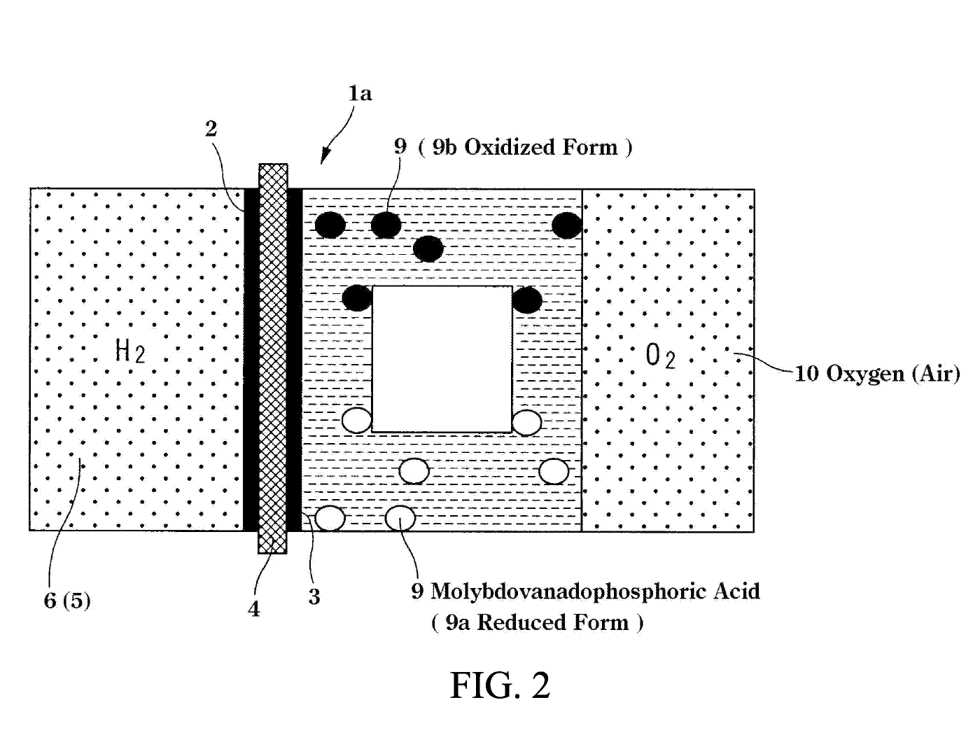

FIG. 2 is a schematic view showing another example of the main part of the fuel cell in accordance with an embodiment of the present invention. For the features identical to those in FIG. 1, identical reference numerals are used without explanations. In a fuel cell 1a, molybdovanadophosphoric acid 9 is used as vanadic acid ion compound of the cathode active material 7, and its aqueous solution is supplied to the cathode 3. The fuel cell is constituted so as to make molybdovanadophosphoric acid 9 contact with oxygen (air) 10, and so as not to make the oxygen contact with the cathode 3 directly. The molybdovanadophosphoric acid 9 is converted into a reduced form 9a through reduction reaction receiving electrons from the hydrogen of the anode active material 5. The reduced form 9a has a property of being oxidized and reconverted into an oxidized form 9b when coming in contact with the oxygen (air) 10. By using this property, the molybdovanadophosphoric acid 9 may be used as a mediator.

In this way, it is made possible for the cathode 3 to indirectly affect on the oxygen (air) 10 via the molybdovanadophosphoric acid 9 as a mediator without direct contact with the oxygen (air) 10. In this system, the molybdovanadophosphoric acid 9 as a mediator is repeatedly reduced and oxidized, however the total quantity remains unchanged. Accordingly, it is not the oxygen (air) 10 but the liquid 8 containing the mediator (molybdovanadophosphoric acid 9) that directly reacts at the cathode 3, allowing the cathode 3 and the oxygen (air) 10 to place apart from each other. In the case that the oxygen (air) 10 reacts directly at the cathode 10, supply of the gas-state oxygen (air) 10 is blocked with the produced water. However, with the use of mediator (molybdovanadophosphoric acid 9), an elaborate control of gas-liquid phases is not required at all since it is not a gas but the liquid 8 to react on the cathode 3.

A platinum catalyst, which is expensive and a rare resource, is generally used in the case that oxygen directly reacts at the cathode such as the case of a conventional fuel cell (DMFC, for example). If the oxidized form 9b serving as a mediator (molybdovanadophosphoric acid 9) is easily reduced on the cathode 3, advantages are brought in: the quantity of the expensive platinum catalyst is reduced, the platinum catalyst is substituted with another inexpensive catalyst, or no platinum catalyst is required. In particular, such reduction in the quantity of platinum in the cathode has a profound effect on the conventional fuel cell, because a larger quantity of the platinum catalyst is used on the cathode. If a large quantity of oxygen (air) 10 dissolves in the liquid (8), the oxygen (air) 10 reacts with the mediator (molybdovanadophosphoric acid 9) in a very large three-dimensional region, so the reaction proceeds rapidly. In other words, the mediator (molybdovanadophosphoric acid 9) itself substantially does not change but does assist the reaction of the oxygen (air) 10 on the cathode 3, that is, it can be regarded as a catalyst. Thus, the liquid 8 containing the mediator (molybdovanadophosphoric acid 9) can be regarded as the liquid 8 containing the catalyst and the replacement of the conventional platinum catalyst, resulting in reduction in the quantity of platinum to be used.

The aforementioned constitution of the present invention in which the liquid 8 containing the nonvolatile cathode active material 7 for being reduced is supplied to the cathode 3 has significant advantages; an elaborate control of gas-liquid phases is not needed, and the platinum catalyst at the cathode 3 is remarkably reduced. Nonetheless, the problem of separation performance of the electrolyte membrane 4 is needed to be solved before applying to practical use of the fuel cell.

If perfluorosulfonic acid system electrolyte membrane having proton conductivity represented by Nafion®, conventionally used, is employed as the proton exchange membrane 4, the liquid 8 containing the cathode active material 7 supplied to the cathode 3 crosses over to a gas side, the anode 2, as is the case of DMFC as described above. Unlike the DMFC case, however, the cathode active material 7 is a nonvolatile solid according to the present invention and keeps to accumulate on the anode 2, inhibiting the electrode reaction. In principle, the cathode active material 7 crossed over to the anode 2 is instantly reduced at the anode 2 and converted into a reduced form. However, the reduced form is also a nonvolatile solid, and thus keeps to accumulate on the anode 2. Accordingly, supplying an aqueous solution of metal ion compound such as molybdovanadophosphoric acid 9, which is originally solid, to the cathode 3 crosses over to the anode 2 and accumulates on it, resulting in inhibition of the electrode reaction.

If the liquid 8 containing the cathode active material 7 is water, the water crossed over to the anode 2 and covers the anode 2, becoming a cause of inhibition of the reaction of hydrogen, the anode active material 5. In the case of DMFC, the water covering the surface of the cathode 3 does not necessarily lead to a significant inhibition since oxygen, the active material of the cathode, has high solubility in water. However, for the anode 2, the water covering the anode 2 becomes a major cause of inhibition since hydrogen has very low solubility in water. It is ideal for fuel cells to operate at higher temperature and to enhance power output. However, it is difficult for Nafion® to operate at high temperature since Nafion® whose glass transition point (softening point) is at around 100° C. allows the liquid 8 contacting with the cathode 3 to cross over more easily at that temperature. Other than Nafion®, there are electrolyte membranes based on hydrocarbon engineering plastics such as PEEK. However, they have less chemical stability such as resistance to oxidation and radical attacks than the electrolyte based on fluorine polymer including Nafion® and, in particular, are likely to cause a problem of durability when used at high temperatures. That is why the conventional electrolyte membranes used in fuel cells, represented by Nafion®, are insufficient to achieve the constitution of the present invention in which the liquid 8 containing the nonvolatile cathode active material 7 for being reduced is supplied to the cathode 3.

According to the present invention, in order to solve the problem by remarkably improving in separation performance of the electrolyte membrane 4, the electrolyte membrane 4 includes the inorganic/organic hybrid compound that is formed by chemical bonding of polyvinyl alcohol with the inorganic compound having at least one compound selected from the group consisting of silicic acid compounds, tungstic acid compounds, and zirconic acid compounds.

The inorganic/organic hybrid compound according to the embodiment of the present invention contains a silicic acid compound, a tungstic acid compound, and/or a zirconic acid compound as constituents. Silicic acid is a SiO₂-based compound containing H₂O with general formula of SiO₂.ₓH₂O, the silicic acid compounds in the embodiment of the present invention mean silicic acid, its derivative, and whole compounds mainly composed of silicic acid. Tungstic acid is a WO₃-based compound containing H₂O with general formula of WO₃.ₓH₂O, the tungstic acid compounds in the embodiment of the present invention mean tungstic acid, its derivative, and whole compounds mainly composed of tungstic acid. Zirconic acid is a ZrO₂-based compound containing H₂O with general formula of ZrO₂.ₓH₂O, the zirconic acid compounds in the embodiment of the present invention mean zirconic acid, its derivative, and whole compounds mainly composed of zirconic acid.

Thus, substitution for a part of the compound with another element, deviation from the stoichiometric composition and addition of additives are allowed as far as the properties of silicic acid, tungstic acid, and zirconic acid are kept. For example, salts and hydroxides of silicic acid, tungstic acid, and zirconic acid are based on SiO₂, WO₃, and ZrO₂, respectively, so derivatives based on the salts or hydroxides and the compounds mainly composed thereof are included in the silicic acid compounds, tungstic acid compounds, and zirconic acid compounds according to the embodiment of the present invention.

The hybrid compound according to the embodiment of the present invention is made of polyvinyl alcohol as constituents. As for the polyvinyl alcohol, it does not have to be sheer one but the one capable of essentially functioning as polyvinyl alcohol may be used. For example, the one in which a part of hydroxyl group is substituted with another group or the one which is partially copolymerized with other polymers functions as polyvinyl alcohol. Further, polyvinyl acetate etc., which are raw material of polyvinyl alcohol, may be used as starting material, because the similar effects are obtained in the case that polyvinyl alcohol is generated in the reaction process according to the embodiment of the present invention.

Insofar as the function of polyvinyl alcohol is sufficiently served, it may be mixed with other polymers or other organic or inorganic additives including: polyolefin-based polymers such as polyethylene and polypropylene; polyacrylic acid-based polymers; polyether-based polymers such as polyethylene oxide and polypropylene oxide; polyester-based polymers such as polyethylene terephthalate and polybutylene terephthalate; fluorine-based polymers such as polytetrafluoroethylene and polyvinylidene fluoride; carbohydrate chain-based polymers such as methylcellulose; polyvinyl acetate-based polymers; polystyrene-based polymers; polycarbonate-based polymers; and epoxy resin-based polymers.

One or more inorganic compounds selected from the group consisting of silicic acid compounds, tungstic acid compounds, and zirconic acid compounds, form the inorganic/organic hybrid compound by combining with polyvinyl alcohol. That is, in the hybrid compound, polyvinyl alcohol and the inorganic compounds are mutually entangled at the molecular level and are strongly bonded through a hydrogen bond and a dehydration condensation through the hydroxyl group of polyvinyl alcohol. The hybrid compound is a chemical compound and distinct from a mixture made by physically mixing polyvinyl alcohol and inorganic compounds. In other words, unlike the mixture, chemical properties of each constituent in the hybrid compound are not necessarily maintained after compounding. In the present invention, for example, polyvinyl alcohol, as one of the constituents of the hybrid compound, itself is soluble in water (hot water), whereas it is essentially insoluble in hot water after forming the hybrid compound with one or more inorganic compounds selected from the above group. Thus, this change in chemical property reveals that the hybrid compound is distinctly different from the mixture which is made by physically mixing.

If the quantity of the inorganic compound is too small with respect to the quantity of polyvinyl alcohol, water resistance, heat resistance, oxidation resistance, and strength of the hybrid compound are insufficient. Conversely, if too large, the flexibility in the hybrid compound is reduced, causing a problem in brittleness. Accordingly, it is preferable to adjust the weight ratio of the total weight of each constituent, SiO₂, WO₃, ZrO₂ to the weight of polyvinyl alcohol is 0.01 to 5.

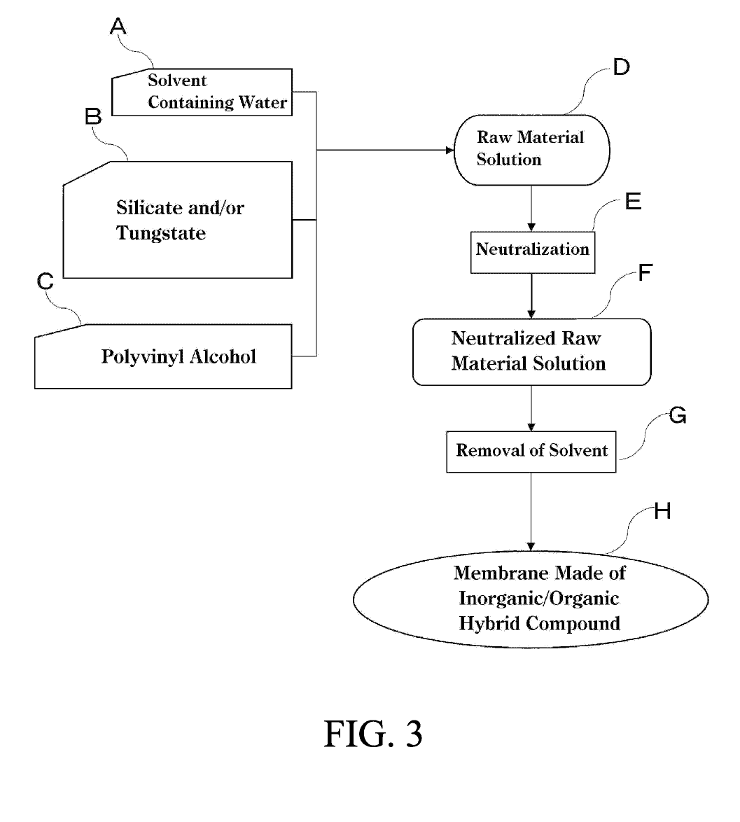

Next, one example of producing the electrolyte membrane 4 according to the embodiment of the present invention will be described with reference to the flowchart of FIG. 3. First, a solvent containing water is prepared in Step A, silicate and/or tungstate are prepared in Step B, polyvinyl alcohol is prepared in Step C, all of which are combined in Step D so as to obtain a raw material solution wherein silicate and/or tungstate and polyvinyl alcohol coexist in the solvent containing water. Any type of silicate and/or tungstate, insofar as they are soluble in water, may be used irrespective of ratios of oxygen and metal ion, and water content. The concentration of polyvinyl alcohol in the raw material solution is preferably equal to or higher than 5 wt. %, more preferably, is equal to or higher than 10 wt. % so as to make the production of the solid electrolyte membrane efficient by removing water from the raw material solution within a limited time for practical production.

Following the above, the silicate and/or tungstate in the raw material solution are neutralized with acid in Step E, and the neutralized raw material solution is obtained in Step F. And then, the solvent is removed in Step G and the membrane made of the inorganic/organic hybrid compound is obtained in Step H.

As for the acid used for neutralizing the silicate and/or tungstate in the raw material solution in Step E, any acid capable of neutralization may be used, for example, hydrochloric acid, sulfuric acid, nitric acid, phosphoric acid, acetic acid, etc. may be used either alone or in combination thereof.

Since the above processes are based on the principal that neutralization of the silicate and/or tungstate in the raw material solution with polyvinyl alcohol coexisting leads to hybridization, it may be possible to obtain the hybrid compound by forming the membrane in advance by removing the solvent as done in Step G before Step E and then making it contact with acid for neutralizing the silicate and/or tungstate in the formed membrane. In this case, there are some method for making the formed membrane contact with acid such as immersing it in an acid solution, applying or spraying an acid solution to it, and exposing it to acid steam.

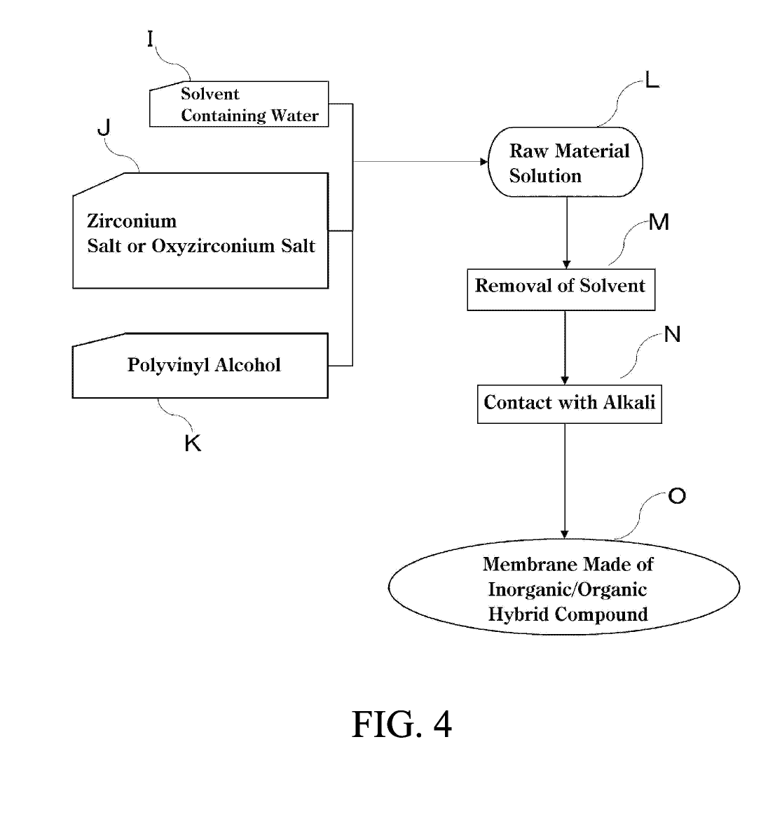

Another example of producing the electrolyte membrane 4 according to the embodiment of the present invention will be described with reference to the flowchart of FIG. 4. First, a solvent containing water is prepared in Step 1, zirconium salt or oxyzirconium salt is prepared in Step J, polyvinyl alcohol is prepared in Step K, all of which are combined in Step L so as to obtain a raw material solution wherein zirconium salt or oxyzirconium salt and polyvinyl alcohol coexist in the solvent containing water. Any type of zirconium salt or oxyzirconium salt, insofar as it is soluble in water, may be used irrespective of ratios of oxygen and metal ion, and water content.

Following the above, the solvent is removed in Step M, and the formed membrane is made contact with alkali in Step N, and then, the membrane made of the inorganic/organic hybrid compound is obtained in Step 0.

In the above processes, as for the alkali used for contact in Step N after removing the solvent, any alkali capable of neutralizing zirconium salt or oxyzirconium salt may be used, for example, sodium hydroxide, potassium hydroxide, lithium hydroxide, ammonia, calcium hydroxide, strontium hydroxide, barium hydroxide, carbonate, etc. may be used either alone or in combination thereof. There are some method for making the formed membrane contact with alkali such as immersing it in an alkali solution, applying or spraying an alkali solution to it, or exposing it to alkali steam.

Subsequently, proton conductivity or hydroxide ion conductivity are imparted to the membrane made of the inorganic/organic hybrid compound produced in the processes as shown in FIGS. 3 and 4 by means of introduction of sulfonic acid group or nitrogen-containing compound with general methods, producing the electrolyte membrane 4 according to the embodiment of the present invention.

The experiment as described below was made in order to confirm that the membrane made of the inorganic/organic hybrid compound shows sufficient performance of separation as the electrolyte membrane for the fuel cell. In particular, it was tried to confirm that the membrane can prevent the liquid 8 containing the nonvolatile cathode active material 7 supplied to the cathode 3 for being reduced, specifically the solution of molybdovanadophosphoric acid 9 from crossing over to the anode 2, enabling less reaction inhibition caused by the crossover than the membrane made of Nafion® which has been conventionally used.

In the experiment, a quantity of crossover was measured with an equipment constituted with two glass chambers having the volume of 40 ml separated by the membrane made of the inorganic/organic hybrid compound. One of the separated chamber was supplied with the solution of molybdovanadophosphoric acid 9 with a concentration of 40%, and the other was supplied with pure water. The equipment was kept for six hours at room temperature, then the concentration of molybdovanadophosphoric acid 9 crossed over to the side of pure water was measured with absorbance analysis. Table 1 shows the result of the above case and the case in which only the membrane is substituted with the one made of Nation®, the conventional membrane.

TABLE 1

| | | | Concentration |
|---|---|---|---|
| | | | on |
| | | Thickness of | Crossover |
| | Electrolyte Membrane | Membrane (μm) | Side |
| Present | Membrane made of the | 20 | 0.026 |
| Invention | inorganic/organic | | |
| | hybrid compound | | |
| Conventional | Membrane made of | 26 | 0.103 |
| Case | Nafion ® | | |

Note)
Concentration on Crossover Side: Concentration of the initially supplied solution of molybdovanadophosphoric acid was defined as 100.

As shown in Table 1, the concentration of the crossover side in the case of inorganic/organic hybrid membrane was 0.026 which is far lower than 0.103 in the case of the Nation® membrane, despite that its thickness is 20 μm, smaller than that of the Nation® membrane 26 μm. The quantity of crossover is decreased to about a quarter in the conventional Nation® membrane, indicating significantly enhanced performance of separation against the solution of molybdovanadophosphoric acid 9. This enables prevention of crossover to the anode 2 of the molybdovanadophosphoric acid 9 in the liquid 8 supplied to the cathode 3, leading to solving the problem of crossover. As a result, a practical fuel cell 1a can be provided, in which the solution of molybdovanadophosphoric acid 9 is used as the liquid 8 supplied to the cathode 3.

The electrolyte membrane 4 containing the inorganic/organic hybrid compound is used with the anode 2 disposed on one side of it and the cathode 3 is disposed on the other side. As for the anode 2 and the cathode 3, anything is available as long as it can function as the fuel cell electrode. As an example, the electrode generally used in fuel cells, which is composed of a mixture of platinum loaded on carbon powder with an electrolyte compound (ionomer), may be used. As for the electrolyte compound in the electrode, the similar compounds to the electrolyte membrane 4 are used, for example, Nafion® ionomer or the inorganic/organic hybrid compound according to the embodiment of the present invention may be used. However, unlike general fuel cells as descried before, the use of platinum catalyst is not necessarily required on the cathode 3 in the case that the solution of molybdovanadophosphoric acid 9 is supplied.

The anode 2 and the cathode 3 are directly applied to the electrolyte membrane 4, otherwise are applied on porous sheets composed of conductive carbon, which are bonded to the electrolyte membrane 4. The porous sheet plays a role to evenly supply the gas 6 and the liquid 8 to the electrode layer of the anode 2 and the cathode 3, respectively, as well as a role of an electric collector for electrode. As examples of the porous sheet, carbon paper, carbon felt, or porous metal may be used. It is effective that the anode 2, to which the gas 6 is supplied, is processed with hydrophobic treatment so as not for water to close pores of the porous sheet. For the same purpose, the porous sheet is disposed on both sides of the electrolyte membrane 4 in the case of direct application of the anode 2 and the cathode 3.

In some case, a microporous layer is disposed between the porous sheet and the electrode, such as the anode 2 and the cathode 3. The microporous layer is composed of, for example, conductive carbon powder and polytetrafluoroethylene (PTFE), and has micro pores. In the invention in which the liquid 8 containing the cathode active material 7 is supplied to the cathode 3, platinum is not necessarily needed, and in that case, the electrode layer composed of platinum loaded on carbon powder with an electrolyte compound is not necessarily needed and thus the microporous layer may function as an electrode.

The MEA (membrane-electrode assembly) constituted in this way is held and fixed between plates for electrical connection (separators) having grooves on their surfaces for supplying the gas 6 and the liquid 8. If a high voltage is required, a plurality of these unit cells connected in series are used.

According to the embodiment of the present invention, the anode 2 is supplied with the gas 6 containing the anode active material 5 to be oxidized on the electrode, whereas the cathode 3 is supplied with the liquid 8 containing the nonvolatile cathode active material 7 to be reduced on the electrode. As for the gas 6 supplied to the anode 2, hydrogen is mainly used. As for the nonvolatile cathode active material 7 contained in the liquid 8 supplied to the cathode 3, various metal ions can be used, especially in terms of oxidation-reduction potential and reactivity, vanadium-based compounds such as vanadic acid compound or manganese-based compounds such as permanganic acid compound are usable. Further, as described before, if the molybdovanadophosphoric acid 9, which is vanadic heteropolyacid, is used, it becomes the reduced form 9a on the electrode and is oxidized with oxygen to be reconverted into the oxidized form 9b, and thus used as a mediator. Water is the best for the liquid 8 to dissolve these substances in terms of solubility of them and chemical stability of the liquid itself.

### Example 1

The anode 2 was made into a layered structure in which a carbon paper of 22.4 mm square with 195 μm in thickness (Toray Industries, Inc.) was disposed as the outermost gas diffusion layer. Inside it, the microporous layer with 10 μm in thickness made of carbon black powder and polytetrafluoroethylene was disposed. Further inside it, the electrode catalyst layer made of platinum loaded on carbon catalyst and Nafion® ionomer was disposed.

The microporous layer was made by mixing acetylene black powder (Denka Co., Ltd.) with polytetrafluoroethylene (PTFE) powder (Sigma-Aldrich Co. LLC.) at the weight ratio of 10:7, which was evenly applied on the carbon paper and then heated at 120° C. for one hour. The mixture of 50 wt. % platinum loaded on carbon catalyst (Tanaka Kikinzoku Kogyo K.K.) and Nafioe ionomer (5% solution DE520 CS type) at the weight ratio of 5:2 was evenly applied on the microporous layer. The amount of application was adjusted so that the amount of platinum per square centimeter of carbon paper was 0.5 mg. After application, the layer was heated at 120° C. for one hour.

The cathode 3 was made in the same manner as the anode 2; however, constituted only with the gas diffusion layer and the microporous layer without the electrode layer containing platinum catalyst, because the liquid 8 containing the cathode active material 7 contacts with it.

The anode 2 and the cathode 3 constituted as described above were attached on both sides of the electrolyte membrane 4 consisting of the membrane of inorganic/organic hybrid compound (iO-Brane® (Nippon Kodoshi Corporation)) with hot press at 100° C., forming the MEA (membrane-electrode assembly).

By using the above MEA, the fuel cell 1a as illustrated in FIG. 2 was composed. Specifically, the MEA was set in a commercial unit cell (ElectroChem, Inc.), and hydrogen as the gas 6 was flown to the anode 2 in a predetermined flow rate and an aqueous solution of molybdovanadophosphoric acid 9 with predetermined concentration as the liquid 8 was flown to the cathode 3 in a predetermined flow rate. The solution for supplying to the cathode 3 was bubbled with the oxygen (air) 10 by using a device used for aquarium in order that the molybdovanadophosphoric acid 9 acting as mediator may react with the oxygen (air) 10. In this operation, the unit cell, the liquid 8, and the gas 6 were adjusted at a predetermined temperature with a heater.

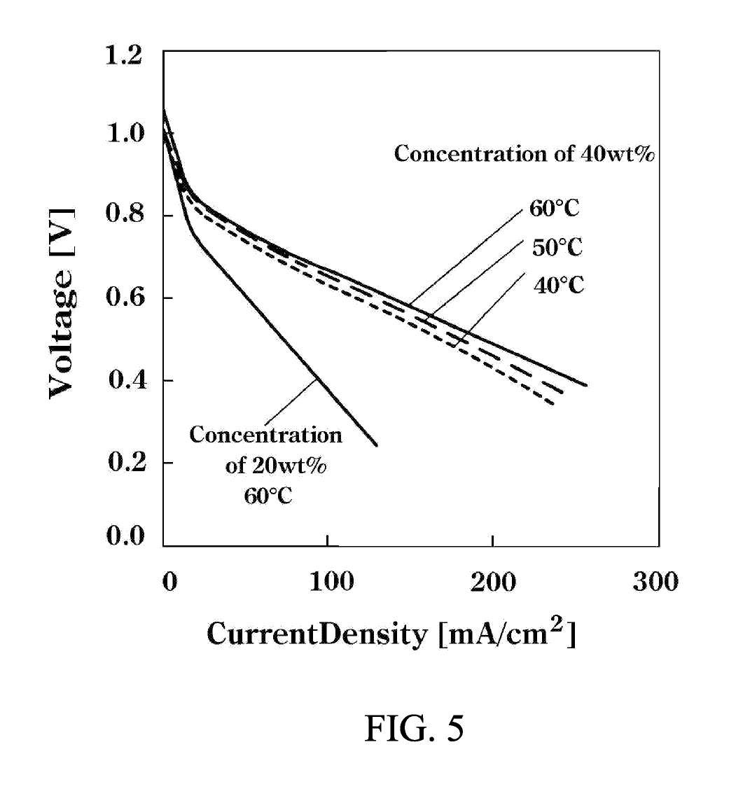

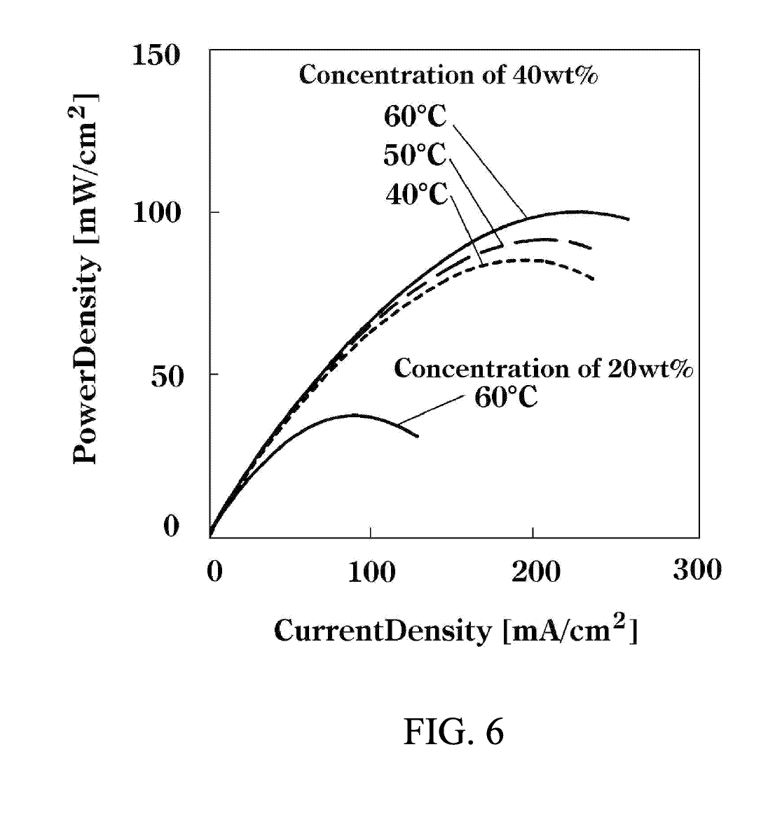

The current-voltage curve obtained by measuring voltage with varying current of the fuel cell 1a constituted as described above is shown in FIG. 5, and the power output curve obtained by converting it is shown in FIG. 6. As obvious from both FIGS. 5 and 6, it has been confirmed that the fuel cell 1a according to the embodiment of the present invention can generate power. It was also confirmed that the liquid 8 containing the nonvolatile cathode active material 7 reduced on the cathode 3 is available for reacting with oxygen indirectly as a liquid mediator, resulting in generating power without platinum catalyst on the cathode 3. Further it was revealed that the power generation performance is enhanced as the concentration and the temperature of the nonvolatile cathode active material 7 (molybdovanadophosphoric acid 9 in Example 1) in the liquid 8 become higher.

### INDUSTRIAL APPLICABILITY

According to the embodiment of the present invention, the use of the membrane made of the inorganic/organic hybrid compound, not a pure organic polymer, enhances the performance of separation as the electrolyte membrane, enabling to solve the problem lying in the fuel cell wherein a gas containing an anode active material for being oxidized is supplied to the anode and a liquid containing a nonvolatile cathode active material for being reduced is supplied to the cathode. That is, preventing the liquid containing the cathode active material supplied to the cathode from crossing over to the anode, thus enabling to mitigate the problem of inhibiting electrode reaction caused by accumulation of nonvolatile cathode active material on the anode. In this way, the practical use of the fuel cell in which an aqueous solution containing the active material is supplied to the cathode is achieved. As a result, the necessity of elaborate advanced control of gas-liquid phases can be eliminated and the quantity of platinum catalyst used in the reacting electrode is largely reduced.

### DESCRIPTION OF THE REFERENCE NUMERAL

1, 1a fuel cell
2 anode
3 cathode
4 electrolyte membrane
5 anode active material
6 gas
7 cathode active material
8 liquid
9 molybdovanadophosphoric acid
9a reduced form
9b oxidized form
10 oxygen (air)

1. A fuel cell comprising:
an anode that is supplied with a gas containing an anode active material for being oxidized;
a cathode that is supplied with a liquid containing a nonvolatile cathode active material for being reduced;
an electrolyte membrane that separates the anode and the cathode; and the electrolyte membrane comprises an inorganic/organic hybrid compound that is formed by chemical bonding of polyvinyl alcohol with an inorganic compound including at least one compound selected from the group consisting of silicic acid compounds, tungstic acid compounds, and zirconic acid compounds.

2. The fuel cell according to claim 1, wherein the anode active material contained in the gas that is supplied to the anode is hydrogen.

3. The fuel cell according to claim 1, wherein the nonvolatile cathode active material contained in the liquid that is supplied to the cathode is selected from the group consisting of vanadic acid ions, manganic acid ions, compounds of vanadic acid ions, and compounds of manganic acid ions.

4. The fuel cell according to claim 1, wherein the nonvolatile cathode active material contained in the liquid that is supplied to the cathode is molybdovanadophosphoric acid.

5. The fuel cell according to claims 1, wherein the liquid that is supplied to the cathode contacts with oxygen, and the reduced form of the nonvolatile cathode active material in the liquid, formed by being reduced on the cathode, is reconverted into an oxidized form by being contacted and oxidized with oxygen.
